(19) United States
(12) Patent Application Publication
(10) Pub. No.: US 2008/0249766 A1
(43) Pub. Date: Oct. 9, 2008

(54) Scalable Decoder And Expanded Layer Disappearance Hiding Method

(75) Inventor: Hiroyuki Ehara, Kanagawa (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., Osaka (JP)

(21) Appl. No.: 11/587,964

(22) PCT Filed: Apr. 25, 2005
(86) PCT No.: PCT/JP2005/007822

§ 371 Date: Oct. 27, 2006

(30) Foreign Application Priority Data
Apr. 30, 2004 (JP) 2004-136280

(51) Int. Cl. G10L 19/14

(52) U.S. Cl. 704/203; 704/201; 704/219; 704/E19.049

(57) ABSTRACT

A scalable decoder which does not frequently switch the band of the decoded signal even if the signal in an expanded layer in band scalable encoding disappear and does not give any strangeness or discomfort to the subjective quality. If frame disappearance does not occur, the signal is a signal (S101). However, if a high-band packet is made to disappear, the actually received signal is only a low-band packet. Therefore, the scalable decoder subjects the signal of a low-band packet to an upsample processing. As a result, a signal (S102) where the sampling rate is a wide band and only the low-frequency component is left is generated. From the signal (S103) of the (n−1)-th frame, a compensation signal (S104) is generated by hiding and passed through an HPF to extract only the high-frequency component to generate a signal (S105). The signal (S101) where only the low-frequency component is left is added to the signal (S105) where high-frequency component is left to generate a decoded signal (S106).

### TECHNICAL FIELD

The present invention relates to a scalable decoding apparatus that performs concealing processing when an enhancement layer is lost, and an enhancement layer loss concealing method used in the apparatus.

### BACKGROUND ART

In packet communication represented by Internet communication, packet losses sometimes occur in a transmission path, and therefore, there is a demand for a so-called scalable coding function which enables decoding processing, when part of transmission information is lost, from the remaining information. There are two types of this scalable coding; one that performs coding by providing scalability for only a bit rate of a signal to be coded without changing frequency band, and one that performs coding by providing scalability for frequency band (frequency axis direction) of a signal to be coded (for example, see Non-Patent Document 1). Especially, the latter which is a scheme of coding by providing scalability for frequency band will be referred to as “band scalable coding.”

In conventional speech communication, a narrow band signal of telephone band (300 Hz to 3.4 Hz) has been used, but in recent years, a scheme of coding a wideband signal (50 Hz to 7 kHz) is also being standardized (for example, see Non-Patent Document 2) and its application for high quality speech communication in the future is expected.

On the other hand, as complete IP implementation in network further proceeds in the future, it is expected that terminals for speech signals of telephone band and terminals for wideband speech will coexist on the same network. Furthermore, multipoint communication as seen in current telephone conference services is said to become widespread. In view of such circumstances, a scalable coding scheme capable of coding/decoding both speech signals of telephone band and wideband speech signals with a single coding scheme is considered highly effective.

Scalable coding schemes for not only speech signals but also acoustic signals of wider band have been disclosed so far (for example, see Patent Documents 1 and 2). Such scalable coding hierarchically codes acoustic signals to be coded and transmits information of a core (basic layer) preferentially using priority control on network such as DiffServ (Differentiated Services). Depending on the state of a transmission path, information of enhancement layers is discarded in descending order of the layer level. This makes it possible to suppress the probability that core information may be discarded in communication network and suppress deterioration of conversation quality even if part of the coded information is lost due to a packet loss .

On the other hand, when the coded information is lost in the transmission path and cannot be received on the decoder side, generally, processing of concealing (compensating for) this data loss is carried out. For example, Patent Document 3 discloses frame loss concealing processing according to ITU-T Recommendation G.729. As disclosed in Patent Document 3, extrapolative concealing processing is carried out on lost frames as a standard using information decoded in the past.
Patent Document 1: Japanese Patent Application Laid-Open No. HEI 08-263096
Patent Document 2: Japanese Patent Application Laid-Open No. 2002-100994
Patent Document 3: Japanese Patent Application Laid-Open No. HEI 09-120297
Non-Patent Document 1: T. Nomura et al, “A Bitrate and Bandwidth Scalable CELP Coder,” IEEE Proc. ICASSP98, pp. 341-344, 1998
Non-Patent Document 2: 3GPP Standard, TS26.190

### DISCLOSURE OF INVENTION

### Problems to be Solved by the Invention

However, in transmission of scalable-coded signals, there is no standard technology for decoding processing when the signal of the enhancement layer is lost.

Furthermore, when only the signal of the enhancement layer is lost, it may be possible to carry out decoding processing on the lost signal using information of the core layer, but this involves the following problem. That is, as described above, when not only the bit rate but also the frequency band is scalable, the decoded signal generated from the information of the core layer is a narrow band signal, whereas the decoded signal generated from both the information of the core layer and information of the enhancement layer becomes a wideband signal. Thus, there is a problem that the frequency band of the decoded signal differs between the case where decoding processing is performed using only the information of the core layer and the case where decoding processing is performed using both the core and enhancement layers. In such a case, even if decoding is performed using only the coded information of the core layer, the signal band only becomes locally narrower, which may not lead to significant quality deterioration. However, when the loss rate of the enhancement layer is high and the band of the decoded signal is frequently switched between the narrow band and the wideband, uncomfortable perception and unpleasantness are caused in the subjective quality of the decoded signal.

It is therefore an object of the present invention to provide a scalable decoding apparatus which prevents band of decoded signals from being frequently switched even when a signal of an enhancement layer is lost in band scalable coding and causes no uncomfortable perception and unpleasantness in subjective quality of the decoded signal, and an enhancement layer loss concealing method used in the apparatus.

### Means for Solving the Problem

The scalable decoding apparatus of the present invention obtains a decoded signal of wideband from coded information made up of a core layer and an enhancement layer having scalability in a frequency axis direction, including: a core layer decoding section that obtains a core layer decoded signal of narrow band from the coded information of the core layer; a conversion section that converts frequency band of the core layer decoded signal of the narrow band to wideband and obtains a first signal; a concealing section that generates a concealed signal of the wideband based on a decoded signal obtained in the past for the coded information which includes the core layer and has lost the enhancement layer; a removal section that removes the frequency component corresponding to the core layer from the concealed signal of the wideband and obtains a second signal; and an addition section that adds the first signal obtained at the conversion section and the second signal obtained at the removal section and obtains a decoded signal of the wideband.

### Advantageous Effect of the Invention

According to the present invention, in band scalable coding, even when a signal of the enhancement layer is lost, it is possible to prevent the band of the decoded signal from frequently being switched and prevent uncomfortable perception and unpleasantness in subjective quality of the decoded signal.

### BRIEF DESCRIPTION OF DRAWINGS

FIG. 1 is a block diagram showing the main configuration of a scalable decoding apparatus according to Embodiment 1;

FIG. 2 is a block diagram showing the main configuration of an internal part of a core decoder according to Embodiment 1;

FIG. 3 is a block diagram showing the main configuration of an internal part of an enhancement decoder according to Embodiment 1;

FIG. 4 illustrates a signal flow during normal operation of the internal part of the enhancement decoder according to Embodiment 1;

FIG. 5 illustrates a signal flow when a frame of the enhancement layer inside the enhancement decoder according to Embodiment 1 is lost;

FIG. 6 illustrates an overview of decoding processing of the scalable decoding apparatus according to Embodiment 1;

FIG. 7 is a block diagram showing the configuration of an up-sampling processing section when the enhancement decoder according to Embodiment 1 is an MDCT-based one;

FIG. 8 is a block diagram showing the main configuration of the scalable decoding apparatus according to Embodiment 2;

FIG. 9 is a block diagram showing the main configuration of a mobile station apparatus and a base station apparatus when the scalable decoding apparatus shown in Embodiment 1 or 2 is applied to a mobile communication system; and

FIG. 10 is a block diagram showing the main configuration of the scalable decoding apparatus combining Embodiments 1 and 2.

### BEST MODE FOR CARRYING OUT THE INVENTION

Hereinafter, embodiments of the present invention will be explained in detail with reference to the accompanying drawings. Here, a case where frequency band is provided with scalability and an input signal is hierarchically coded/decoded, that is, coded information has scalability in the frequency axis direction will be explained as an example. In such a case, a signal in the narrowest band is coded/decoded in the core layer.

### Embodiment 1

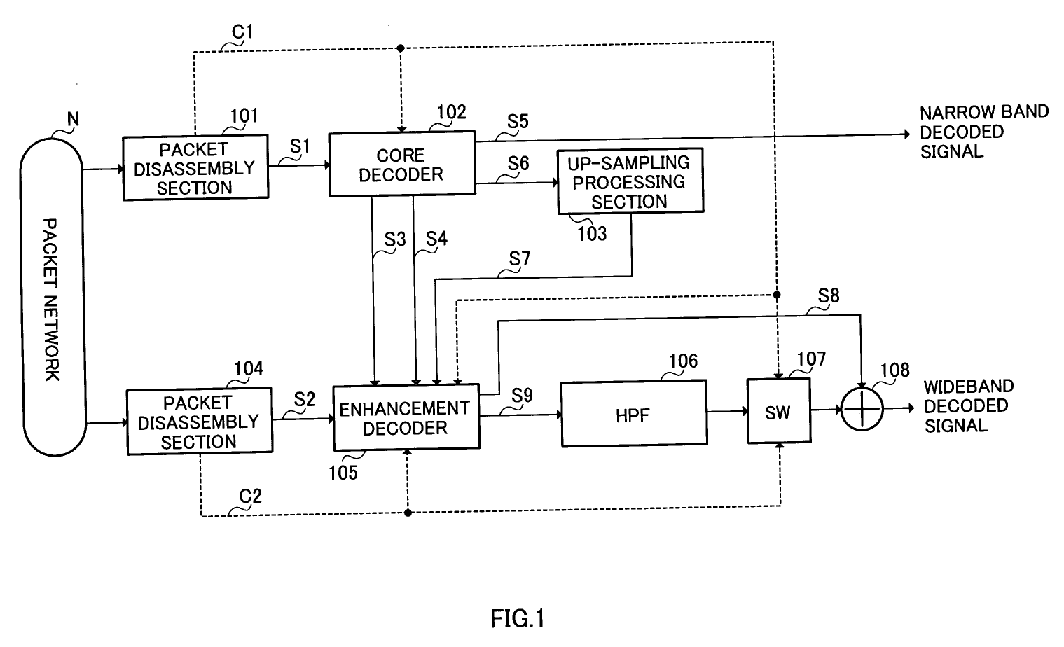

FIG. 1 is a block diagram showing the main configuration of the scalable decoding apparatus according to Embodiment 1 of the present invention.

The scalable decoding apparatus according to this embodiment is provided with packet disassembly section 101 for a core coded packet, core decoder (core decoding processing section) 102, up-sampling processing section 103, packet disassembly section 104 for an enhancement coded packet, enhancement decoder (enhancement decoding processing section) 105, high pass filter (HPF) 106, changeover switch (SW) 107 and adder 108.

The respective sections of the scalable decoding apparatus according to this embodiment will perform the following operation.

Packet disassembly section 101 for a core coded packet extracts coded information of a core layer from the core coded packet carrying the coded information of the core layer inputted through packet network N, outputs the coded information to core decoder 102 (S1) and outputs frame loss information C1 to core decoder 102, enhancement decoder 105 and changeover switch 107. Here, the “coded information” refers to a coded bit stream which is outputted from a coding apparatus (not shown) on the transmitting side and “frame loss information C1” is information which indicates whether or not a frame to be decoded is a lost frame. When the packet to be decoded is a lost packet, all frames included in this packet become lost frames.

Core decoder 102 performs decoding processing on the core layer using frame loss information C1 and coded information S1 outputted from packet disassembly section 101 and outputs decoded signal (narrow band signal) S3 of the core layer. Specific contents of the decoding processing on the core layer may be, for example, decoding processing based on a CELP model or may be decoding processing based on waveform coding or may be decoding processing of a transform coding model using MDCT. Furthermore, core decoder 102 outputs part or all of the information obtained through the decoding processing on the core layer (S4) to enhancement decoder 105. The information outputted to enhancement decoder 105 is used for decoding processing on the enhancement layer. Moreover, core decoder 102 outputs signal S6 obtained through the decoding processing on the core layer to up-sampling processing section 103. Signal S6 outputted to up-sampling processing section 103 may be the decoded signal of the core layer or may be a partial decoded parameter (for example, a spectral parameter or excitation parameter) depending on the coding model of the core layer.

Up-sampling processing section 103 performs processing of increasing a Nyquist frequency on the decoded signal outputted from core decoder 102 or partial decoded parameter or decoded signal obtained in the decoding process. This up-sampled signal S7 is outputted to enhancement decoder 105. This up-sampling processing is not limited to the processing on the time axis. In some type of scalable coding algorithms, the signal after the up-sampling processing may be outputted to enhancement excitation decoder 122 so as to be used for enhancement excitation decoding.

On the other hand, packet disassembly section 104 for the enhancement coded packet extracts coded information of the enhancement layer from the enhancement coded packet carrying the coded information of the enhancement layer inputted through the packet network, outputs the information to enhancement decoder 105 (S2) and outputs frame loss information C2 to enhancement decoder 105 and changeover switch 107.

Enhancement decoder 105 performs decoding processing on the enhancement layer using frame loss information C2 and coded information S2 outputted from packet disassembly section 104, decoded signal S3 outputted from core decoder 102 and information S4 obtained in the coding process of the core layer and signal S7 obtained by up-sampling the decoded signal of the core layer outputted from up-sampling processing section 103, obtains a decoded signal (wideband signal) of the enhancement layer and outputs the decoded signal to HPF 106 and adder 108 (S8 and S9). Signal S8 outputted to adder 108 need not be identical to signal S9 outputted to HPF 106. For example, enhancement decoder 105 may output signal S7 outputted from up-sampling processing section 103 to adder 108 or may conditionally switch it with reference to frame loss information C2.

HPF 106 allows only a high-frequency component (band component not included in the narrow band decoded signal of the core layer) of decoded signal S9 inputted from enhancement decoder 105 to pass and outputs the high-frequency components to changeover switch 107.

Changeover switch (SW) 107 switches between ON/OFF of the output to adder 108 of the signal outputted from HPF 106. ON/OFF of the switch is switched with reference to the frame loss information outputted from packet disassembly section 101 for the core coded packet and packet disassembly section 104 for the enhancement coded packet. More specifically, when neither the core layer nor the enhancement layer has frame loss (i.e. both layers receive good frames), the switch is opened and set to OFF. On the other hand, when only the core layer receives good frames and the enhancement layer has lost frames, the switch is closed and set to ON. Moreover, when both the core layer and the enhancement layer have lost frames, the switch is opened and set to OFF.

Adder 108 adds an acoustic signal of full band directly inputted from enhancement decoder 105 and a high-frequency band decoded signal inputted through HPF 106 from enhancement decoder 105 and outputs the addition result as a wideband signal.

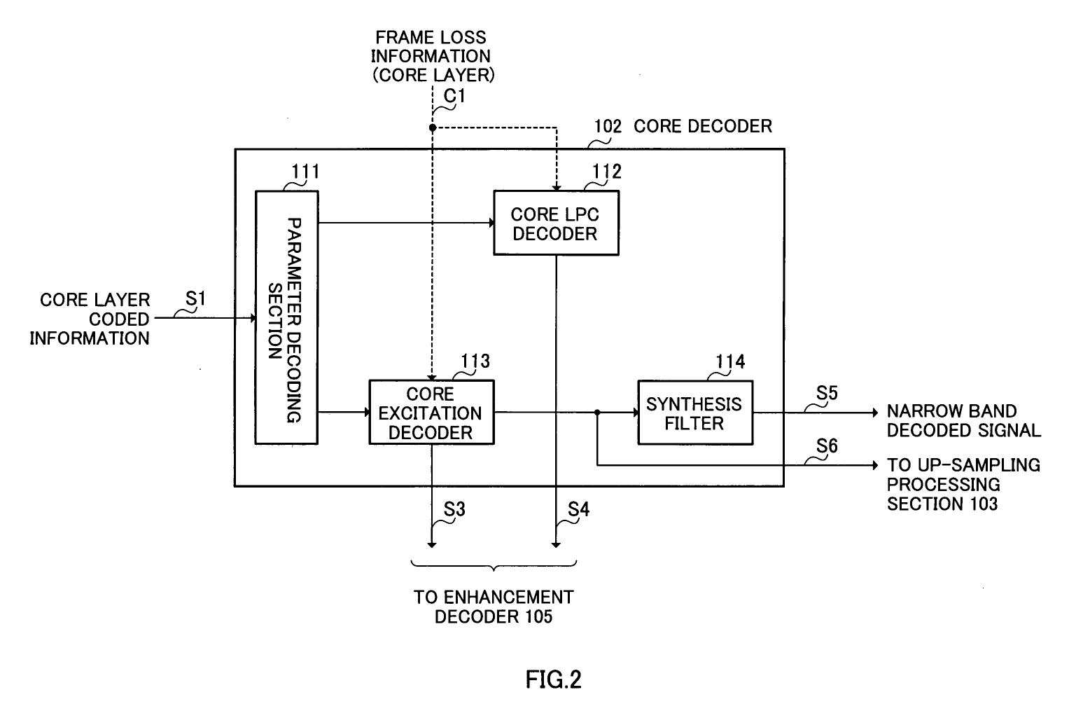

FIG. 2 is a block diagram showing the main configuration of an internal part of the above-described core decoder 102.

This core decoder 102 is provided with parameter decoding section 111, core linear predictive coefficient (LPC) decoder 112, core excitation decoder 113 and synthesis filter 114.

Parameter decoding section 111 separates coded information (bit stream) S1 of the core layer outputted from packet disassembly section 101 into LPC parameter coded data (including an LSP code or the like) and excitation parameter coded data (including a pitch lag code, code of a fixed excitation codebook and gain code or the like), decodes respective data to various codes to output to core (layer) LPC decoder 112 and core excitation decoder 113.

Core LPC decoder 112 decodes the code of the LPC parameter outputted from parameter decoding section 111 and outputs decoded LPC to synthesis filter 114 and enhancement decoder 105. To be more specific, in the decoding processing, for example, the LSP parameter coded using vector quantization is decoded, and the decoded LSP parameter is converted to an LPC parameter. When frame loss information C1 outputted from packet disassembly section 101 for the core coded packet indicates that the current frame is a lost frame, core LPC decoder 112 carries out concealing processing on the LPC parameter using frame loss compensation processing and outputs LPC (compensation signal) generated through the concealing processing as decoded LPC.

Core excitation decoder 113 performs decoding processing on various codes of the excitation parameter (such as pitch lag, fixed codebook, gain codebook) outputted from parameter decoding section 111 and outputs the decoded excitation signal to synthesis filter 114 and up-sampling processing section 103 (S6). Furthermore, core excitation decoder 113 outputs part or all of information S3 decoded through this decoding processing to enhancement decoder 105. More specifically, pitch lag information and a pulse excitation signal (fixed codebook excitation information) or the like are outputted from core excitation decoder 113 to enhancement decoder 105. When frame loss information C1 inputted from packet disassembly section 101 for the core coded packet indicates that the current frame is a lost frame, core excitation decoder 113 carries out concealing processing on the excitation parameter using frame erasure concealment processing and outputs the concealed excitation signal generated through the concealing processing as the decoded excitation signal.

Synthesis filter 114 is the linear prediction filter whose filter coefficients are decoded LPC outputted from core LPC decoder 112 and is excited by the decoded excitation signal outputted from core excitation decoder 113 and outputs narrow band signal S5.

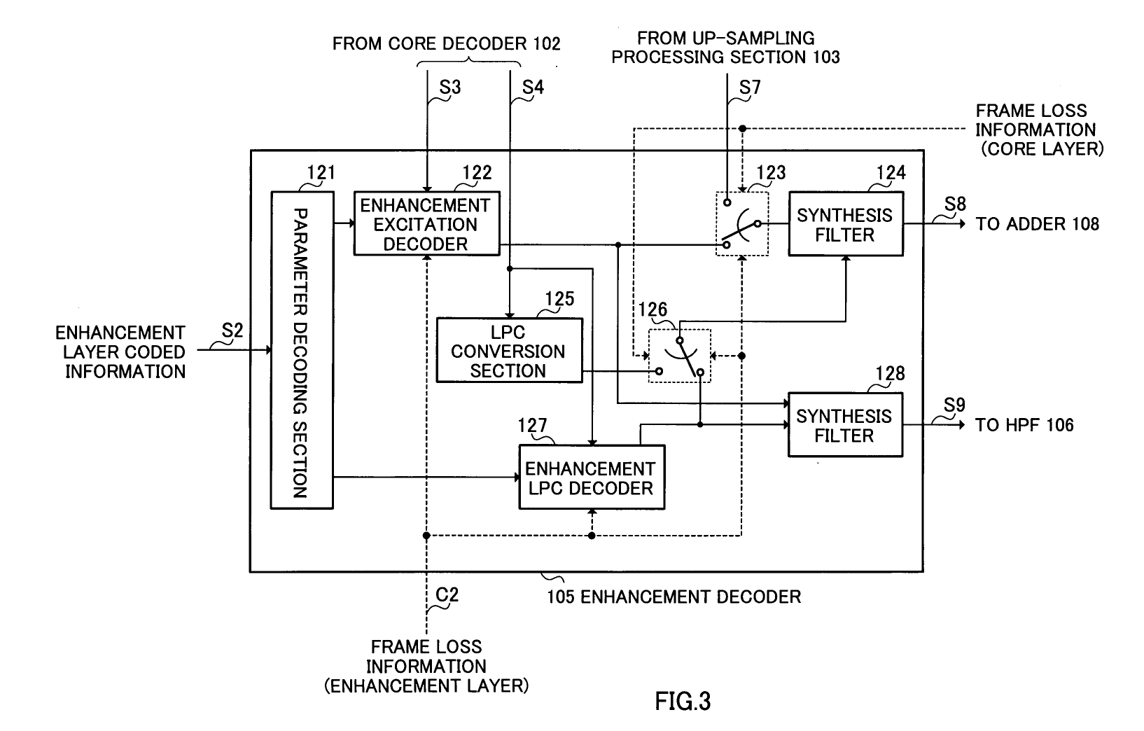

FIG. 3 is a block diagram showing the main configuration of an internal part of enhancement decoder 105.

This enhancement decoder 105 is provided with parameter decoding section 121, enhancement excitation decoder 122, two changeover switches (123 and 126), two synthesis filters (124 and 128), LPC conversion section 125 and enhancement LPC decoder 127.

Parameter decoding section 121 receives coded information S2 of the enhancement layer from packet disassembly section 104, separates it into LPC parameter coded data (including LSP code or the like) and excitation parameter coded data (including a pitch lag code, fixed codebook index code, gain code or the like), decodes them into codes of various parameters and outputs them to enhancement LPC decoder 127 and enhancement excitation decoder 122 respectively.

Enhancement LPC decoder 127 decodes the LPC parameter to re-synthesize a wideband signal using decoding core LPC parameter S4 inputted from core LPC decoder 112 in core decoder 102 and the enhancement layer LPC parameter code inputted from parameter decoding section 111 and outputs the decoded LPC parameter to the two synthesis filters (outputs the decoded LPC parameter to synthesis filter 124 through changeover switch 126). More specifically, enhancement LPC decoder 127 uses a model for predicting enhancement LSP (wideband LSP) from decoded LSP (narrow band LSP) inputted from core LPC decoder 112. In this case, enhancement LPC decoder 127 performs a series of processing such as processing of decoding the prediction error of the wideband LSP that is predicted from the narrow band LSP (such prediction error is coded using MA predictive vector quantization, for example), reconstructing the final wideband LSP by adding the decoded prediction error to the wideband LSP that is predicted from the narrow band LSP and finally converting it to LPC.

When the frame loss information inputted from the packet disassembly section for the enhancement coded packet indicates that the current frame is a lost frame, enhancement LPC decoder 127 performs concealing processing on the LPC parameter using the frame erasure concealment processing and outputs the concealed LPC generated through the concealing processing as decoded LPC. Other methods may also be used for the decoding processing.

LPC conversion section 125 converts narrow band LPC parameter S4 to a wideband LPC parameter. As an example of this up-sampling method, there is a method of up-sampling an impulse response of the LPC synthesis filter obtained from narrow band LSP, obtaining an auto-correlation from the up-sampled impulse response and converting the obtained auto-correlation coefficients to LSP having desired orders, but this is by no means limiting. Conversion between auto-correlation coefficients Ri and LPC parameter ai can be realized using the fact that there is a relationship expressed by (Equation 1) below between the two.

$$\begin{matrix}[ Equation 1 ] & \\ [ \begin{matrix}{R}_{0} & {R}_{1} & … & {R}_{p - 1} \\ {R}_{1} & {R}_{0} & … & {R}_{p - 2} \\ ⋮ & ⋮ & ⋰ & ⋮ \\ {R}_{p - 1} & {R}_{p - 2} & … & {R}_{0}\end{matrix} ] [ \begin{matrix}{a}_{1} \\ {a}_{2} \\ ⋮ \\ {a}_{p}\end{matrix} ] = - [ \begin{matrix}{R}_{1} \\ {R}_{2} \\ ⋮ \\ {R}_{p}\end{matrix} ] & ( 1 )\end{matrix}$$

The converted LPC parameter is outputted to synthesis filter 124 through changeover switch 126. Though not shown, when such a coding model that decodes enhancement LPC using the converted LPC parameter is used, the converted LPC parameter is also outputted to enhancement LPC decoder 127.

Enhancement excitation decoder 122 receives various types of code information of the enhancement excitation parameter from parameter decoding section 121 and receives information obtained through the core excitation decoding processing such as decoded information of the core excitation parameter and decoded core excitation signal from core excitation decoder 113. Enhancement excitation decoder 122 carries out decoding processing on the enhancement excitation (wideband excitation) signal and outputs the decoded signal to synthesis filter 124 and synthesis filter 128 (however, output to synthesis filter 124 is performed through switch 123).

When enhancement excitation decoder 122 performs decoding processing based on, for example, a CELP scheme, this processing includes pitch lag decoding processing, decoding processing on an adaptive codebook component, decoding processing on a fixed codebook component, decoding processing on a gain parameter or the like.

The decoding processing on a pitch lag is performed, for example, as follows. A pitch lag for enhancement excitation is subjected to differential quantization using the pitch lag information inputted from core excitation decoder 113, and therefore enhancement excitation decoder 122 converts the pitch lag for core excitation to a pitch lag for enhancement excitation by doubling the pitch lag for core excitation when the the sampling frequency is doubled in the enhancement layer, and, on the other hand, decodes the pitch lag (delta lag) subjected to difference quantization. Then, enhancement excitation decoder 122 uses the sum of the pitch lag converted for enhancement excitation and the delta lag obtained through the decoding as the decoded pitch lag for the enhancement excitation.

In the decoding processing on an adaptive codebook component, enhancement excitation decoder 122 generates the adaptive codebook component using, for example, the adaptive codebook for enhancement excitation decoder 122, that is, a buffer of the excitation signal generated from enhancement excitation decoder 122 in the past and decodes the adaptive codebook component.

In the decoding processing on a fixed codebook component, enhancement excitation decoder 122 uses the fixed codebook inputted from core excitation decoder 113 after sampling rate conversion as one component of the fixed codebook in the enhancement excitation decoding processing. Furthermore, enhancement excitation decoder 122 is separately provided with a fixed codebook in the enhancement excitation codebook and decodes the additional fixed codebook component by performing decoding processing. A decoded excitation signal is obtained by multiplying the decoded adaptive codebook component and fixed codebook component by the corresponding decoded gain parameters respectively and adding the two components.

When the frame loss information inputted from the packet disassembly section for the enhancement coded packet indicates that the current frame is a lost frame, enhancement excitation decoder 122 carries out concealing processing on the excitation parameter using the frame erasure concealment processing and outputs the concealed excitation signal generated through the concealing processing as a decoded excitation signal.

Changeover switch 123 connects any of up-sampling processing section 103 and enhancement excitation decoder 122 to synthesis filter 124 and performs changeover based on frame loss information C1 inputted from packet disassembly section 101 for the core coded packet and frame loss information C2 inputted from packet disassembly section 104 for the enhancement coded packet. More specifically, when the core layer is a good frame and the enhancement layer is a lost frame, the input terminal of synthesis filter 124 is connected to the output terminal of up-sampling processing section 103, and, otherwise, the input terminal of synthesis filter 124 is connected to the output terminal of enhancement excitation decoder 122.

Changeover switch 126 connects any one of LPC conversion section 125 and enhancement LPC decoder 127 to the second input terminal of synthesis filter 124 and performs changeover based on frame loss information C1 inputted from packet disassembly section 101 for the core coded packet and frame loss information C2 inputted from packet disassembly section 104 for the enhancement coded packet. More specifically, when the core layer is a good frame and the enhancement layer is a lost frame, the second input terminal of synthesis filter 124 is connected to the output terminal of LPC conversion section 125, and, otherwise, the second input terminal of synthesis filter 124 is connected to the output terminal of enhancement LPC decoder 127.

Synthesis filter 124 receives filtering coefficients from enhancement LPC decoder 127 or LPC conversion section 125 through switch 126 and forms a synthesis filter using these filtering coefficients. The formed synthesis filter is excited with the excitation signal inputted from enhancement excitation decoder 122 or up-sampling processing section 103 through switch 123, and output signal S8 is outputted to the adder. Synthesis filter 124 continues to generate signals with no errors unless the frame of the core layer is lost.

Synthesis filter 128 forms a synthesis filter with the filtering coefficients inputted from enhancement LPC decoder 127 and is excited with the decoded excitation signal inputted from enhancement excitation decoder 122, and output signal S9 is outputted to high pass filter 106. Synthesis filter 128 always generates a decoded signal of the wideband regardless of the presence/absence of a frame loss.

HPF 106, which receives the output signal of synthesis filter 128, is a filter which shuts off some band of the decoded signal of core decoder 102 and allows only a high-frequency component (which is the band extended in the enhancement layer) to pass and outputs it to switch 107. The high pass filter preferably has a linear phase characteristic, but this is by no means limiting.

Changeover switch 107 turns ON/OFF the input of a signal to the adder and is switched based on the frame loss information inputted from the packet disassembly section for the core coded packet and the frame loss information inputted from the packet disassembly section for the enhancement coded packet. More specifically, when the core layer is a good frame and the enhancement layer is a lost frame, the switch is closed, and the output of HPF 106 is inputted to the adder. Otherwise, changeover switch 107 is opened, and the output of HPF 106 is not inputted to the adder.

Adder 108 adds the decoded signal outputted from synthesis filter 124 and the decoded signal having only the high-frequency component inputted from changeover switch 107 and outputs the addition result as the final wideband decoded signal.

When a frame loss occurs in the enhancement layer, that is, when the bandwidth of the output signal of synthesis filter 124 is narrowed, synthesis filter 128 adds the high-frequency component extracted at HPF 106 and the decoded signal of the narrow band generated by synthesis filter 124 and outputs the addition result. As a result, a decoded signal having wideband is always obtained. That is, it is possible to prevent subjective uncomfortable feeling caused by change of the bandwidth of the decoded signal. Furthermore, if the information of the enhancement layer is lost, the low-frequency component is not affected, so that it is possible to generate a high quality wideband signal. This is because the low-frequency component of the signal is important to the human auditory perception, and deterioration of the quality caused by distortion of the low-frequency component (such as a pitch period) is considerable for the coding/decoding based on the CELP scheme, so that, if the low-frequency component is free of errors, it is possible to reduce deterioration of subjective quality even if errors are mixed into the high-frequency component.

When the core layer constitutes a bit rate scalable decoder, the packet for core coding can be divided into the same number of portions as the layers in the bit rate scalable configuration. In this case, packet disassembly sections for core coding are also provided according to the number of layers. When information other than the core layer of the bit rate scalable coded information (referred as bit rate scalable core) is lost in the packet network, it is assumed that the various types of information outputted from core decoder 102 in FIG. 1 is obtained only through the decoding processing of the bit rate scalable core of core decoder 102. On the other hand, when only some enhancement layers of the bit rate scalable enhancement layers other than the bit rate scalable core are lost, it is possible to perform decoding processing of the core decoder using part of the information of the bit rate scalable core and the correctly received bit rate scalable enhancement layers.

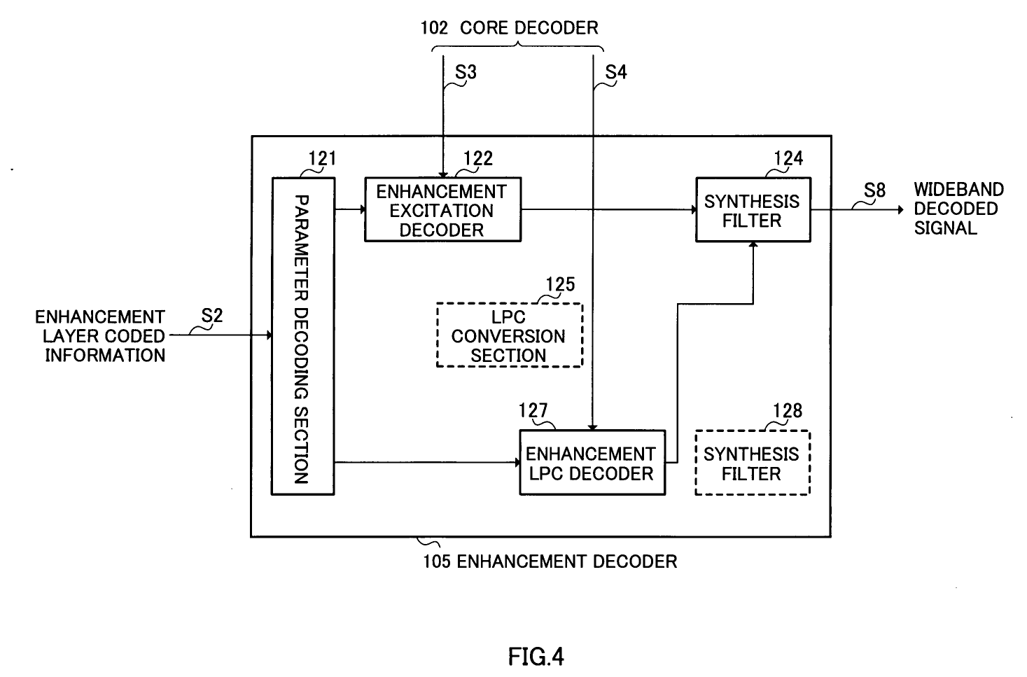

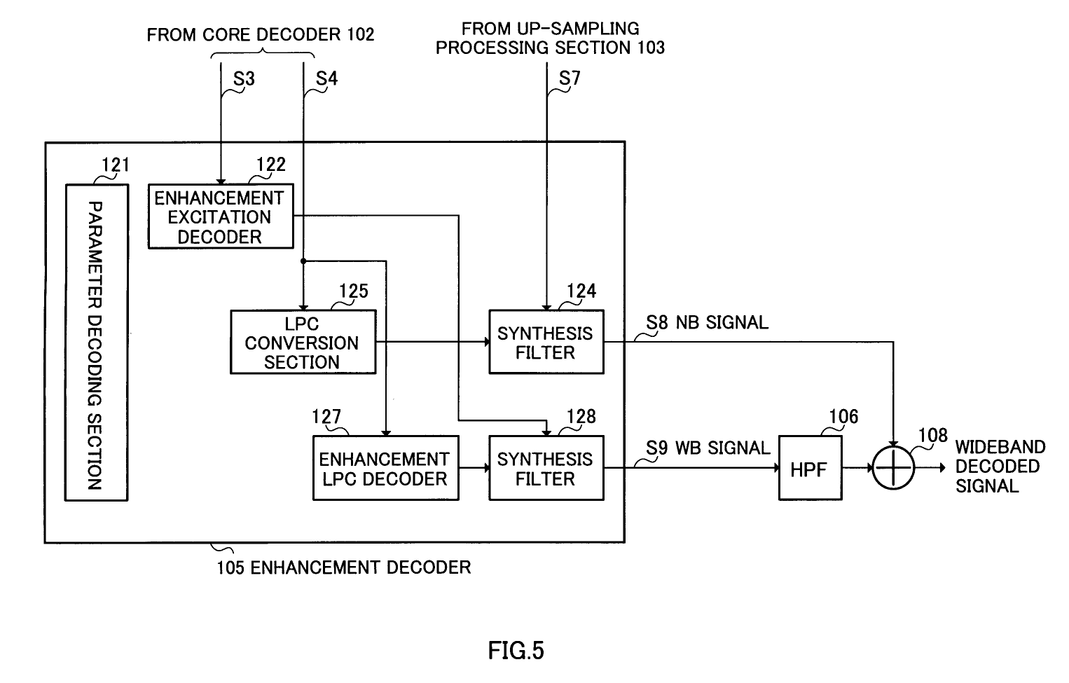

FIG. 4 and FIG. 5 show signal flows of the internal part of enhancement decoder 105 which has been explained above. FIG. 4 shows a signal flow when there is no frame loss, that is, signal flow during a normal time, and FIG. 5 shows a signal flow when a frame in the enhancement layer is lost. An NB signal in the figure indicates a narrow band signal, and a WB signal indicates a wideband signal.

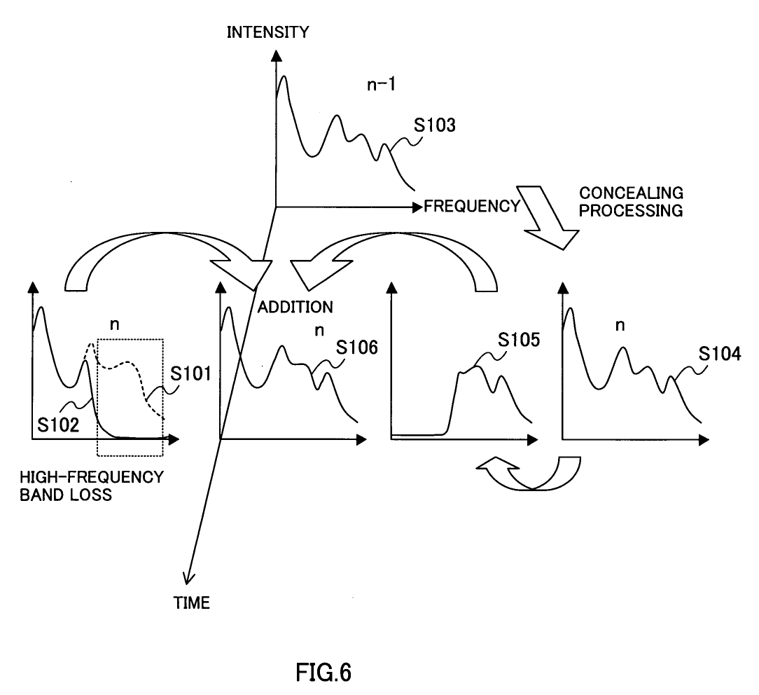

Next, an overview of the decoding processing of the scalable decoding apparatus in the above configuration will be explained using the signal diagram shown in FIG. 6. This figure shows a case where frame loss has occurred in an nth frame.

Signal S101 expressed with a dotted line shows a signal when there is no frame loss. However, when a high-frequency band (enhancement layer) packet of this signal is lost in the transmission path, the actually received signal becomes only a low-frequency packet. Therefore, this embodiment performs up-sampling processing or the like on the signal decoded from this low-frequency packet and generates signal S102 (signal expressed with a solid line) whose sampling rate is wideband and in which only the low-frequency component contains. On the other hand, concealed signal S104 is generated through concealing processing based on signal S103 in the (n−1)th frame. When only the high-frequency component is extracted by allowing this signal S104 to pass through HPF, signal S105 is obtained. By adding signal S101 in which only the low-frequency component contains and signal S105 in which only the high-frequency component contains at addition section 108, decoded signal S106 is obtained.

In this way, this embodiment generates a signal by up-sampling a signal obtained using coded information of the core layer which is the correctly received error-free (i.e. with no error) low-frequency component, adds a signal obtained by extracting only the high-frequency component of the signal of full band generated using error concealing processing in the enhancement layer to this signal and obtains a full band decoded signal.

By adopting this configuration, even if coded information other than the core layer of the band scalable acoustic coded information is lost, it is possible to always generate not only acoustic signal band supported by the core layer but also acoustic signal band supported by the enhancement layer.

Furthermore, the sampling rate of the decoded signal obtained only from the coded information of the core layer remains unchanged as the same wideband decoded signal, but the bandwidth of the output signal of the synthesis filter decreases or increases depending on the error situation of the enhancement layer. That is, when the frame of the enhancement layer is lost, the bandwidth of the decoded signal become narrowed. However, according to this embodiment, it is possible to prevent the bandwidth of the decoded acoustic signal from changing in a short time and prevent unpleasantness and uncomfortable perception from occurring in the decoded acoustic signal. Moreover, the quality of the low-frequency component does not deteriorate.

When priority control over packet transfer is being carried out on packet network in band scalable acoustic decoding, if only the coded data in the enhancement layer is lost, the bandwidth of the decoded signal may change on the decoder side, and auditory unpleasant perception may be produced. By adding the high-frequency component of the decoded signal in the enhancement layer decoded using frame erasure concealment processing to the decoded signal in the core layer decoded in an error-free condition, it is possible to avoid the bandwidth of the decoded signal from changing over time and acquire stable quality in perception on the decoder side.

Furthermore, the configuration is adopted whereby the decoded information on the core layer is used to adaptively switch between the coding/decoding of the enhancement layer and the frame erasure concealment processing, so that, even if the information of the enhancement layer is lost, as long as the information of the core layer is received correctly, it is possible to obtain a high quality decoded signal.

Moreover, it is possible to realize high quality acoustic communication quality by effectively using priority control on the packet network.

In this embodiment, the case has been explained as an example where the enhancement layer consists of one layer, but the number of the enhancement layers may also be two or more (the number of types of the frequency band to be outputted may be two or more).

Furthermore, the core layer may have a hierarchical structure (scalable coder/scalable decoder)having bit rate scalability.

Furthermore, the coding/decoding algorithm whereby each frequency band is outputted may have a hierarchical structure having bit rate scalability.

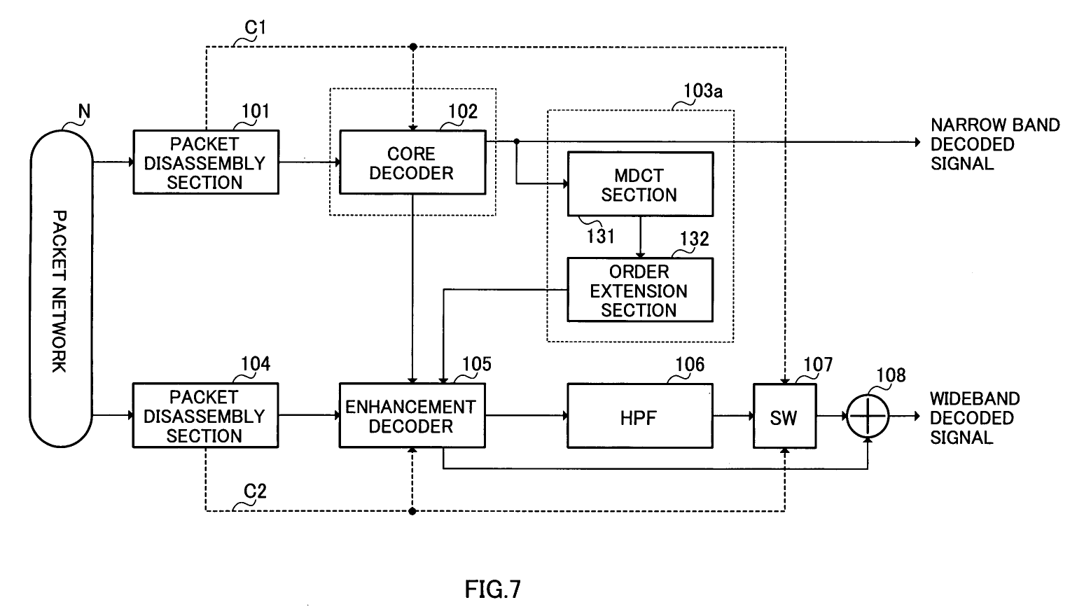

Furthermore, enhancement decoder 105 may also be an MDCT-based one. FIG. 7 is a block diagram showing the configuration of up-sampling processing section 103a when enhancement decoder 105 is an MDCT-based one.

This up-sampling processing section 103a is provided with MDCT section 131 and order extension section 132.

Core decoder 102 outputs a core decoded signal as narrow band decoded signal and also outputs it to MDCT section 131. This is equivalent to a case where two output signals (S3 and S4) of core decoder 102 shown in FIG. 1 are identical. Furthermore, core decoder 102 outputs part or all of the information obtained in the decoding process of the core layer to enhancement decoder 105.

MDCT section 131 performs modified discrete cosine transform (MDCT) processing on the narrow band decoded signal outputted from core decoder 102 and outputs the obtained MDCT coefficients to order extension section 132.

Order extension section 132 extends the order of the MDCT coefficients outputted from MDCT section 131 by zero filling (when double up-sampling is performed, the MDCT order is doubled by filling the increased part with coefficients “0”). The extended MDCT coefficients are outputted to enhancement decoder 105.

Enhancement decoder 105 generates a decoded signal of the enhancement layer by performing inverse modified discrete cosine transform on the MDCT coefficients outputted from order extension section 132. On the other hand, when performing concealing processing, enhancement decoder 105 adds the enhancement information generated through the concealing processing to the MDCT coefficients outputted from order extension section 132 and generates a decoded signal of the enhancement layer by performing inverse modified discrete cosine transform on the MDCT coefficients generated by the adding operation performed in enhancement decoder 105.

### Embodiment 2

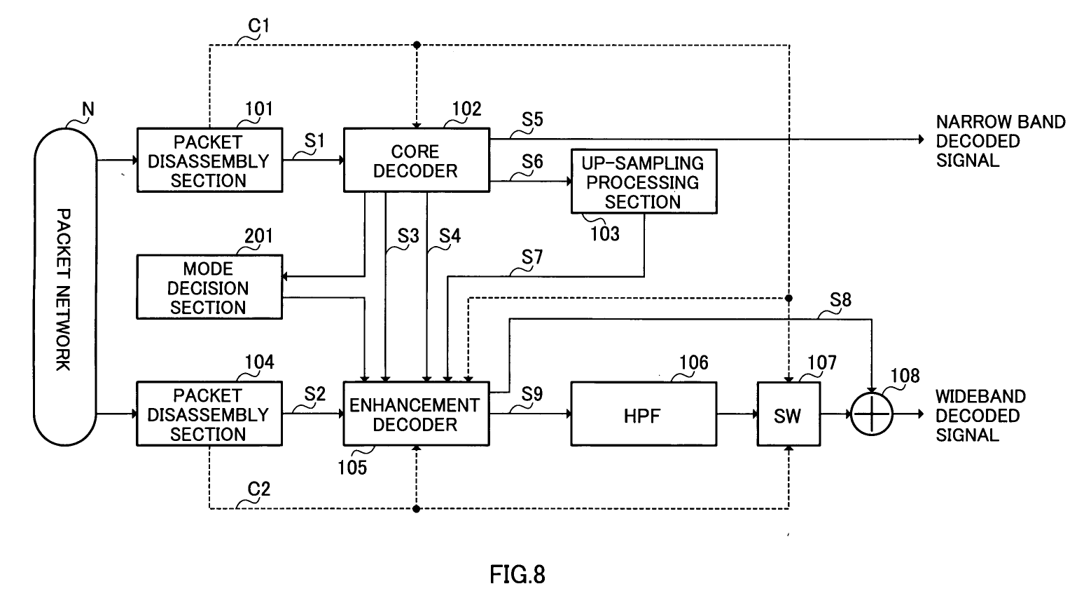

FIG. 8 is a block diagram showing the main configuration of a scalable decoding apparatus according to Embodiment 2 of the present invention. This scalable decoding apparatus has a basic configuration similar to that of the scalable decoding apparatus shown in Embodiment 1, and components that are identical are assigned the same reference numerals without further explanations.

The scalable decoding apparatus according to this embodiment is provided with mode decision section 201 and differs from Embodiment 1 in the operation of core decoder 102 and enhancement decoder 105 having an input/output interface with mode decision section 201.

Next, the operation of the scalable decoding apparatus which has the above configuration will be explained.

Core decoder 102 performs decoding processing on a core layer using frame loss information C1 and core layer coded information S1 inputted from packet disassembly section 101 to output as decoded signal (narrow band signal) S6 of the core layer. Furthermore, core decoder 102 outputs part or all of the information obtained in the decoding processing of the core layer to enhancement decoder 105. The information outputted to enhancement decoder 105 is used for the decoding processing on the enhancement layer. Moreover, core decoder 102 outputs the signal obtained through the decoding processing on the core layer to up-sampling processing section 103 and the mode decision section. The signal to be outputted to up-sampling processing section 103 may be the decoded signal of the core layer or may be a partial decoded parameter depending on the coding model of the core layer. The information to be outputted to the mode decision section generally includes parameters used to classify the condition (silence, voiced stationary part, noise-like consonant part, onset, transient part or the like) of a speech signal such as linear predictive coefficients, pitch prediction gain, pitch lag, pitch period, signal energy, zero crossing rate, reflection coefficients, log area ratio, LSP parameter and normalized linear prediction residual power.

Using various types of information inputted from core decoder 102, mode decision section 201 classifies the signal being decoded (for example, a noise-like consonant part, voiced stationary part, onset part, voiced transient part, silence part, musical signal) and outputs this classification result to enhancement decoder 105. However, classification is not limited to this example.

Enhancement decoder 105 performs decoding processing on the enhancement layer using the frame loss information and coded information outputted from packet disassembly section 104, information obtained in the coding process of the core layer outputted from core decoder 102 and a signal obtained by up-sampling the decoded signal of the core layer inputted from up-sampling processing section 103. When coding processing on the enhancement layer is performed by such an enhancement coder (not shown) that selectively uses a coding model suitable for the mode using the mode information inputted from the mode decision section, similar processing is also performed for the decoding processing.

In this way, by adopting a configuration so that a situation of the present acoustic signal is judged in the core layer and the coding models of the enhancement layer are switched adaptively, it is possible to realize higher quality coding/decoding.

A decoded signal is outputted to HPF 106 and adder 108 as the decoded signal (wideband signal) of the enhancement layer. The signal outputted to adder 108 and the signal outputted to HPF 106 need not be the same. For example, the signal inputted from up-sampling processing section 103 may be outputted to adder 108 as is. Moreover, the signal to be outputted to adder 108 maybe conditionally switched with reference to the frame loss information (for example, the signal inputted from up-sampling processing section 103 and the signal generated through the decoding processing carried out in enhancement decoder 105 may be switched).

Furthermore, when the frame loss information indicates that the current frame is a lost frame, enhancement decoder 105 performs frame erasure concealment processing. In this case, because the information indicating the mode of the acoustic signal is inputted from the mode decision section, the concealing processing suitable for the mode is performed. The wideband signal generated using the concealing processing is outputted to the adder through HPF 106 and the switch. HPF 106 can be realized with a digital filter in the time domain, but it is also possible to use such processing that the signal is transformed to the frequency domain using orthogonal transform such as MDCT and then reconverted to the time domain through inverse transformation with only a high-frequency component left.

Core LPC decoder 112 outputs the acoustic parameter obtained in the decoding process of LPC or the acoustic parameter obtained from decoded LPC (for example, a reflection coefficient, log area ratio, LSP, normalized linear prediction residual power) to the mode decision section.

Core excitation decoder 113 outputs the acoustic parameter obtained in the process of the excitation decoding or the acoustic parameter obtained from the decoded excitation signal (for example, pitch lag, pitch period, pitch gain, pitch prediction gain, excitation signal energy, excitation signal zero crossing rate) to mode decision section 201.

Though not shown, it is more preferable to provide an analysis section that analyzes zero crossing rate and energy information or the like of the narrow band decoded signal outputted from the synthesis filter and input these parameters to the mode decision section.

Mode decision section 201 receives the various acoustic parameters (LSP, LPC, reflection coefficient, log area ratio, normalized linear prediction residual power, pitch lag, pitch period, pitch gain, pitch prediction gain, excitation signal energy, excitation signal zero crossing rate, synthesized signal energy, synthesized signal zero crossing rate or the like) from core LPC decoder 112 and core excitation decoder 113, performs mode classification of the acoustic signal (silence part, noise-like consonant part, voiced stationary part, onset part, voiced transient part, ending of a word, musical signal or the like) and outputs the classification result to enhancement LPC decoder 127 and enhancement excitation decoder 122. Though not shown, when enhancement decoder 105 is provided with a post-processing section like a post-filter, the above-described mode classification information may also be outputted to this post-processing section.

Enhancement LPC decoder 127 may switch decoding processing according to various types of modes of the acoustic signal inputted from mode decision section 201. In this case, it is assumed that an enhancement LPC coder (not shown) also performs similar switching processing on coding models. Furthermore, when frame loss occurs in the enhancement layer, the frame loss concealing processing corresponding to the above-described mode is performed to produce decoded enhancement LPC.

Enhancement excitation decoder 122 may switch decoding processing according to various types of modes of the acoustic signal inputted from mode decision section 201. In this case, it is assumed that an enhancement excitation coder (not shown) also performs similar switching between coding models. Furthermore, when frame loss has occurred in the enhancement layer, the frame erasure concealment processing corresponding to the above-described mode is performed to produce a decoded enhancement excitation signal.

### Embodiment 3

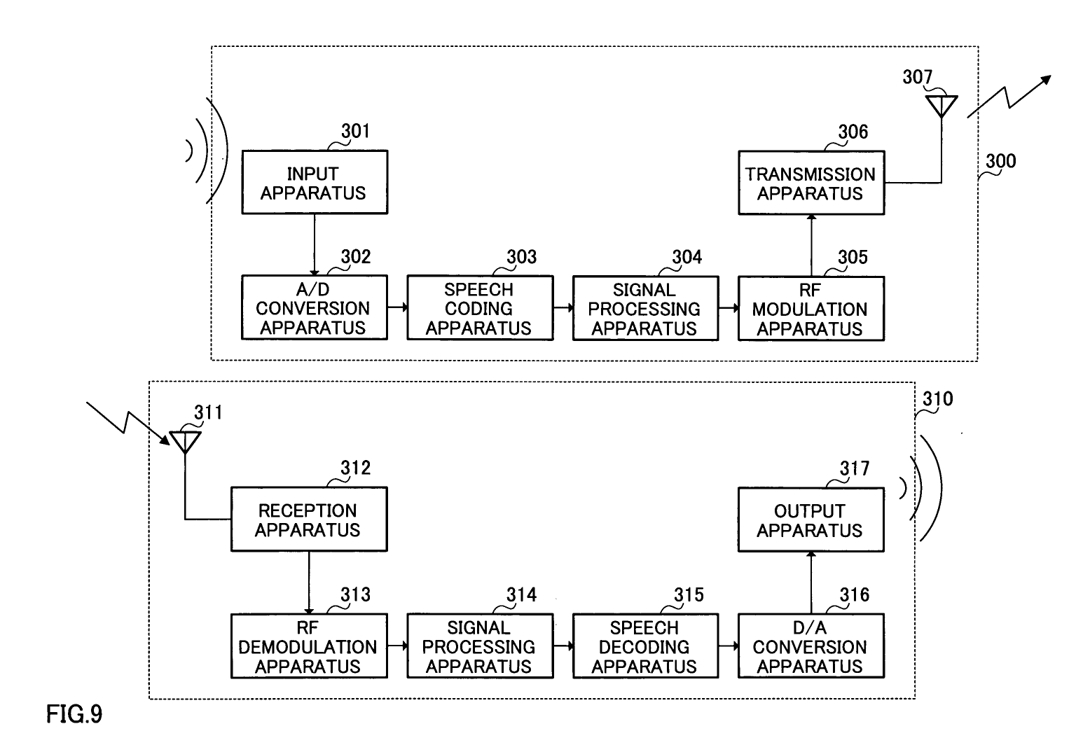

FIG. 9 is a block diagram showing the main configuration of a mobile station apparatus and a base station apparatus in a case where the scalable decoding apparatus shown in Embodiment 1 or 2 is applied to a mobile communication system.

This mobile communication system is provided with speech signal transmission apparatus 300 and speech signal reception apparatus 310. The scalable decoding apparatus shown in Embodiment 1 or 2 is mounted on speech signal reception apparatus 310.

Speech signal transmission apparatus 300 is provided with input apparatus 301, A/D conversion apparatus 302, speech coding apparatus 303, signal processing apparatus 304, RF modulation apparatus 305, transmission apparatus 306 and antenna 307.

An input terminal of A/D conversion apparatus 302 is connected to an output terminal of input apparatus 301. An input terminal of speech coding apparatus 303 is connected to an output terminal of A/D conversion apparatus 302. An input terminal of signal processing apparatus 304 is connected to an output terminal of speech coding apparatus 303. An input terminal of RF modulation apparatus 305 is connected to an output terminal of signal processing apparatus 304. An input terminal of transmission apparatus 306 is connected to an output terminal of RF modulation apparatus 305. Antenna 307 is connected to an output terminal of transmission apparatus 306.

Input apparatus 301 receives a speech signal and converts this signal to an analog speech signal which is an electric signal to give to A/D conversion apparatus 302. A/D conversion apparatus 302 converts the analog speech signal from input apparatus 301 to a digital speech signal to give to speech coding apparatus 303. Speech coding apparatus 303 codes the digital speech signal from A/D conversion apparatus 302 and generates a speech coded bit sequence to give to signal processing apparatus 304. Signal processing apparatus 304 performs channel coding processing, packetizing processing, transmission buffer processing or the like on the speech coded bit sequence from speech coding apparatus 303 and then gives the speech coded bit sequence to RF modulation apparatus 305. RF modulation apparatus 305 modulates the signal of the speech coded bit sequence subjected to channel coding processing or the like from signal processing apparatus 304 to give to transmission apparatus 306. Transmission apparatus 306 sends out the modulated speech coded signal from RF modulation apparatus 305 as a radio wave (RF signal) through antenna 307.

Speech signal transmission apparatus 300 performs processing on the digital speech signal obtained through A/D conversion apparatus 302 on a frame of few dozens of milliseconds basis. When the system is configured with a packet network, coded data of one frame or several frames is put into one packet, and this packet is sent out to the packet network. When the above-described network is a circuit switched network, neither packetizing processing nor transmission buffer processing is necessary.

Speech signal reception apparatus 310 is provided with antenna 311, reception apparatus 312, RF demodulation apparatus 313, signal processing apparatus 314, speech decoding apparatus 315, D/A conversion apparatus 316 and output apparatus 317.

An input terminal of reception apparatus 312 is connected to antenna 311. An input terminal of RF demodulation apparatus 313 is connected to an output terminal of reception apparatus 312. An input terminal of signal processing apparatus 314 is connected to an output terminal of RF demodulation apparatus 313. An input terminal of speech decoding apparatus 315 is connected to an output terminal of signal processing apparatus 314. An input terminal of D/A conversion apparatus 316 is connected to an output terminal of speech decoding apparatus 315. An input terminal of output apparatus 317 is connected to an output terminal of D/A conversion apparatus 316.

Reception apparatus 312 receives a radio wave (RF signal) which contains speech coded information through antenna 311 and generates a received speech coded signal which is an analog electric signal and gives this to RF demodulation apparatus 313. The radio wave (RF signal) received through antenna 311 is completely the same as the radio wave (RF signal) sent out from speech signal transmission apparatus 300 if there is no attenuation of the signal or superimposition of noise in the transmission path.

RF demodulation apparatus 313 demodulates the received speech coded signal from reception apparatus 312 and gives this to signal processing apparatus 314. Signal processing apparatus 314 performs jitter absorption buffering processing, packet assembly processing and channel decoding processing or the like on the received speech coded signal from RF demodulation apparatus 313 and gives the received speech coded bit sequence to speech decoding apparatus 315. Speech decoding apparatus 315 performs decoding processing on the received speech coded bit sequence from signal processing apparatus 314, generates a decoded speech signal to give to D/A conversion apparatus 316. D/A conversion apparatus 316 converts the digital decoded speech signal from speech decoding apparatus 315 to an analog decoded speech signal to give to output apparatus 317. Output apparatus 317 converts the analog decoded speech signal from D/A conversion apparatus 316 to vibration of the air to output as a sound wave audible to the human ear.

In this way, it is possible to provide a mobile station apparatus (communication terminal apparatus) which has similar operation effects as in Embodiment 1 or 2.

Furthermore, the scalable decoding apparatus according to the present invention is not limited to the above-described embodiments and can be implemented by modifying in various ways. For example, Embodiments 1 and 2 can be implemented in combination as appropriate.

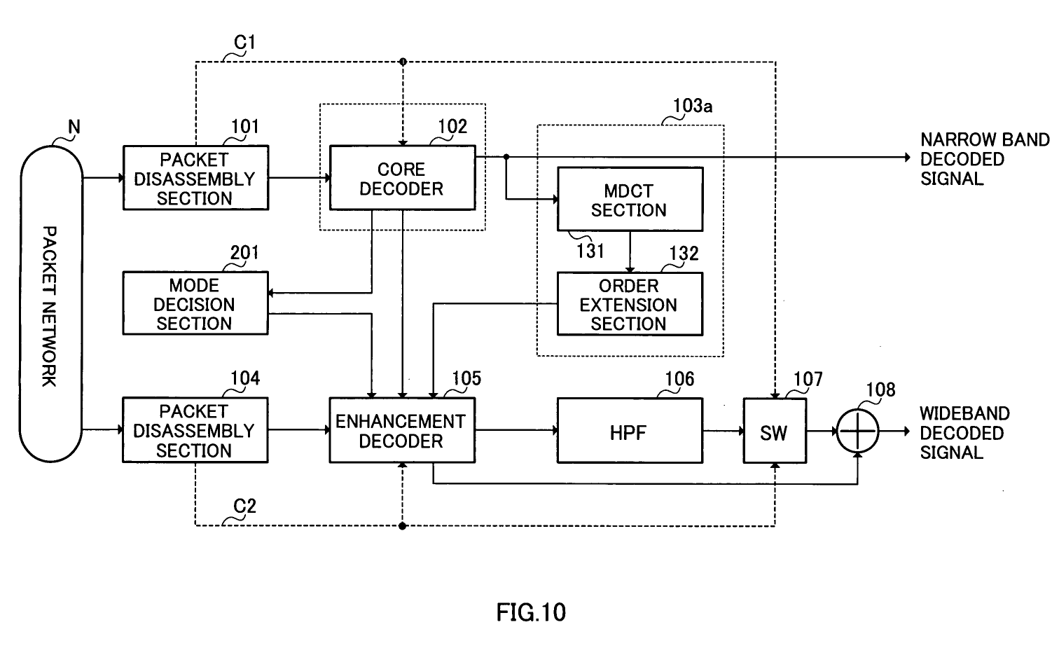

FIG. 10 is a block diagram showing the main configuration of a scalable decoding apparatus combining Embodiments 1 and 2.

Core decoder 102 outputs an acoustic parameter obtained by analyzing the acoustic parameter or the decoded signal obtained in the decoding process to mode decision section 201. Examples of the acoustic parameter include all of various types of parameters as described above. Such a configuration is effective when enhancement decoder 105 uses a coding algorithm using MDCT.

Various embodiments of the present invention have been explained so far.

Here, the case where the present invention is implemented by hardware has been explained as an example, but the present invention can also be implemented by software. For example, the functions similar to those of the scalable decoding apparatus according to the present invention can be realized by describing an algorithm of the enhancement layer loss concealing method according to the present invention in a programming language, storing this program in a memory and causing an information processing section to execute the program.

Furthermore, a cosine of LSP, that is, cos (L(i)) when LSP is L(i) is particularly called an “LSF (Line Spectral Frequency)” and may be distinguished from LSP, but according to the present specification, LSF is one form of LSP and the term “LSP” is used assuming that LSF is included in LSP. That is, LSP may be read as LSF.

The above-described embodiments have explained the case where the core layer is a layer in which coding/decoding is performed on the narrowest band, but when there are layer X which codes/decodes a signal in a given band and layer Y which codes/decodes a signal in a wider band, it is possible to apply the contents of the present invention considering X as a core layer and Y as an enhancement layer. In this case, layer X need not always be the layer for coding/decoding the signal in the narrow band, and layer X may have a scalable structure which consists of a plurality of layers.

Each function block used to explain the above-described embodiments may be typically implemented as an LSI constituted by an integrated circuit. These may be individual chips or may partially or totally contained on a single chip.

Furthermore, here, each function block is described as an LSI, but this may also be referred to as “IC”, “system LSI”, “super LSI”, “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor in which connections and settings of circuit cells within an LSI can be reconfigured is also possible.

Further, if integrated circuit technology comes out to replace LSI's as a result of the development of semiconductor technology or a derivative other technology, it is naturally also possible to carry out function block integration using this technology. Application in biotechnology is also possible.

The present application is based on Japanese Patent Application No. 2004-136280 filed on Apr. 30, 2004, the entire content of which is expressly incorporated by reference herein.

### INDUSTRIAL APPLICABILITY

The scalable decoding apparatus and the enhancement layer loss concealing method according to the present invention can be applied to a communication terminal apparatus or the like in a mobile communication system.

1-7. (canceled)

8. A scalable decoding apparatus for decoding a wideband speech coded parameter using narrowband speech coded information of a narrowband speech signal and obtaining a wideband speech decoded signal using the decoded wideband speech coded parameter, comprising:
a narrowband speech decoding section that obtains a narrowband speech coded parameter using the narrowband speech coded information;
a conversion/generation section that converts said narrowband speech coded parameter to a wideband speech coded parameter and generates a first signal using said wideband speech coded parameter;
a concealing processing section that generates a wideband concealment signal using the wideband speech coded parameter decoded in the past based on frame loss information;
a removal section that removes a frequency component corresponding to the frequency band of the narrowband speech signal from said wideband concealment signal and obtains a second signal; and
an addition section that adds said first signal and said second signal and obtains a wideband speech decoded signal.

9. The scalable decoding apparatus according to claim 8, wherein:
said narrowband speech decoding section comprises:
a narrowband LPC decoding section that obtains decoded LPC for the narrowband speech signal from the narrowband speech coded parameter; and
a narrowband excitation signal decoding section that obtains a decoded excitation signal for the narrowband speech signal from the narrowband speech coded parameter;
said conversion/generation section comprises:
an LPC order conversion section that converts the order of decoded LPC for said narrowband speech signal to LPC for a wideband speech signal;
an up-sampling processing section that up-samples the decoded excitation signal for said narrowband speech signal to the excitation signal for said wideband speech signal; and
a first synthesis filter that is made up of LPC whose order is converted to LPC for the wideband speech signal at said LPC order conversion section and synthesizes said first signal using the excitation signal for the wideband speech signal up-sampled at said up-sampling processing section as an excitation signal; and
said concealing processing section comprises: a wideband LPC decoding section that generates concealed LPC based on the wideband decoded LPC obtained from the wideband speech coded parameter decoded in the past;
a wideband excitation signal decoding section that generates a concealed excitation signal of the wideband based on the decoded excitation signal for the wideband speech signal obtained from the wideband speech coded parameter decoded in the past; and
a second synthesis filter that is made up of concealed LPC generated at said wideband LPC decoding section and synthesizes said wideband concealed signal using the concealed excitation signal generated at said wideband excitation signal decoding section as an excitation signal.

10. The scalable decoding apparatus according to claim 8, wherein:
said narrowband speech decoding section generates a narrowband speech decoded signal using said narrowband speech coded parameter;
said conversion/generation section receives said narrowband speech decoded signal instead of said narrowband speech coded parameter and generates a first signal using said narrowband speech decoded signal; and
said conversion/generation section comprises:
an MDCT section that performs a modified discrete cosine transform on said narrowband speech decoded signal and obtains
MDCT coefficients; and
an order extension section that extends the order of said MDCT coefficients and generates said first signal.

11. The scalable decoding apparatus according to claim 8, further comprising a mode decision section that judges the mode of said concealing processing section using the decoded parameter outputted from said narrowband speech decoding section and obtains a decision result,
wherein said concealing processing section changes a method of generating said wideband compensation signal according to said decision result.

12. A communication terminal apparatus comprising the scalable decoding apparatus according to claim 8.

13. A base station apparatus comprising the scalable decoding apparatus according to claim 8.

14. A frame loss concealing method applied to a scalable decoding method for decoding a wideband speech coded parameter using narrowband speech coded information of a narrowband speech signal and obtaining a wideband speech decoded signal using the decoded wideband speech coded parameter, said frame loss concealing method comprising the steps of:
obtaining a narrowband speech coded parameter using the narrowband speech coded information;
converting said narrowband speech coded parameter to a wideband speech coded parameter and generating a first signal using said wideband speech coded parameter;
generating a wideband concealment signal using the wideband speech coded parameter decoded in the past based on frame loss information;
removing a frequency component corresponding to the frequency band of the narrowband speech signal from said wideband concealment signal and obtaining a second signal; and
adding said first signal and said second signal and obtaining a wideband speech decoded signal.
